(19) United States
(12) Patent Application Publication
(10) Pub. No.: US 2021/0108704 A1
(43) Pub. Date: Apr. 15, 2021

(54) BLOCK LOCK FOR ROUND STEEL CHAINS FOR MINING

(71) Applicant: Schmiedestueck-Vertrieb Feuerstein GmbH, Hattingen (DE)

(72) Inventor: Till STUKENBERG, Bochum (DE)

(73) Assignee: Schmiedestueck-Vertrieb Feuerstein GmbH, Hattingen (DE)

(21) Appl. No.: 17/131,186

(22) Filed: Dec. 22, 2020

Related U.S. Application Data
(63) Continuation of application No. PCT/DE2019/100581, filed on Jun. 24, 2019.

(30) Foreign Application Priority Data
Jun. 22, 2018 (DE) 10 2018 115 129.2

(51) Int. Cl. F16G 15/02

(52) U.S. Cl. CPC F16G 15/02

(57) ABSTRACT

A block lock for round steel chains, having two half-elements which are displaceable relative to one another for opening and closing the block lock and which each have ends connected to one another via a longitudinal web, of which in each case one end has an insertion plug with a width reduced in relation to the longitudinal web and with retaining webs integrally formed on both sides, wherein at least two parallel retaining webs are arranged above one another on each side, and of which in each case the other end has a receiving pocket which serves to receive the insertion plug and on the two lateral inner flanks of which there are in each case formed at least two retaining grooves above one anotherto form a toothing by receiving the retaining webs. A central web extends inwardly from at least one longitudinal web.

This nonprovisional application is a continuation of International Application No. PCT/DE2019/100581, which was filed on Jun. 24, 2019, and which claims priority to German Patent Application No. 10 2018 115 129.2, which was filed in Germany on Jun. 22, 2018, and which are both herein incorporated by reference.

### BACKGROUND OF THE INVENTION

### Field of the Invention

The present invention relates to a block lock for round steel chains for mining.

### Description of the Background Art

Chain locks are used in the mining industry for transmitting high tensile forces, for example in shearing systems, so as to lengthen chains or repair broken chains. The chain locks have to be separable into halves in order to be attached to available chain links of one chain end. The requirements set for the chain lock lies not only in being able to reliably transmit the high tensile forces within the part of the chain but also in offering a sufficient strength in the event that the chain lock on account of an oblique orientation, for example on a deflection roller, is not stressed along the longitudinal axis but in a manner oblique or even transverse to said longitudinal axis. Moreover, the geometry has to be specified such that the adjoining chain elements can be reliably received but are also able to continue to move. Finally, the chain lock is to run within the part of the chain and also to be able to be guided over deflection installations or other guiding installations without catching thereon.

In the case of chain locks for the use in mining, a distinction is made between flat locks according to DIN 22258-1 and block locks according to DIN 22258-2. The flat lock is used in the shearing chain, whereas the block lock is predominantly used in conveyor chains. The flat lock can run horizontally as well as vertically through the chain wheel. The block lock must run only vertically through the chain wheel.

A block lock of the generic type is known from DE 203 07 184 U1 and is designed such that the height measured transversely to the longitudinal extent of the part of the chain is not greater than the height of the adjacent chain links. On account of two retaining grooves and two retaining webs being provided for connecting the half-elements, a reliable transmission of force is achieved even when the block lock runs about a deflection wheel, for example, wherein force that are oblique to the longitudinal axis and can be transmitted by the overlapping flanks on the guide grooves and guide webs arise.

The disadvantage of the known block lock lies in that said block lock can only be assembled by way of an assembly direction which is aligned so as to be transverse to the longitudinal extent of the part of the chain. To this end, the two chain ends first have to be held so as to be free from one another. One half-element of the block lock is inserted into each of the chain ends. The half-elements are then mutually displaced such that the retaining webs can be pushed into the associated retaining grooves. Once the half-elements have been assembled so as to form the chain lock and have been mutually secured by a safety pin, the block lock still has to be pivoted by 90° from the assembly position to the use position of said block lock in order for the latter to be incorporated in the longitudinal extent of the part of the chain. In view of the significant dimensions and the resulting masses of mining chains and the associated block locks, the vertical assembly is not simple and cannot be carried out by one person alone. The known block lock cannot be readily assembled in the case of chain pieces which lie on a subsurface. Moreover, it is necessary for a continuous eye to be formed for both chain links conjointly in the block lock, the length of said eye being significantly larger than double the diameter of the chain links, this resulting in a void. Since the chain links that are connected by way of the known block lock are not separated by a central web there is the risk of tilting, that is to say that both chain links can come to lie beside one another on one side of the eye such that the block lock is not pulled along in the longitudinal direction of the chain but potentially runs sideways.

### SUMMARY OF THE INVENTION

It is therefore an object of the present invention to improve a block lock of the type mentioned at the outset such that assembling in the lying-down part of the chain is possible and that moreover two eyes which in the completely assembled block lock are mutually separated by a central web are configured, one chain-link being in each case being guided in said eyes.

This object is achieved by a block lock for round steel chains for mining, having a shortened closing distance but at the same time also providing a central web.

The use in mining is relevant to the extent that reference is thus made to a specific dimension of the chain links to be connected, to high masses of the half-elements of the block lock, and to corresponding high forces for the assembly. The use of block locks configured according to the invention is not precluded for other fields of application in which similar dimensions are present, for example anchor chains.

In the half-elements of the block lock according to the invention a toothing in multiple stages is provided, as is known per se. Said toothing is in each case formed by two parallel retaining webs and retaining grooves which are disposed in the center of the completed block lock so as to be level with the receptacles for the chain links. On account thereof, the flanks of the retaining grooves and retaining webs remain largely unstressed as long as the chain is being guided in a linear manner, and only a temporary stress of the flanks arises on the deflection points or in the case of the chain being obliquely positioned for other reasons.

A substantial feature of the block lock according to the invention lies in that the retaining webs and retaining grooves are in each case configured so as to be of dissimilar lengths and disposed on receptacle regions which are formed by insertion plugs and receptacle pockets. The insertion plug having the outward-projecting retaining webs at the separation plane has the longer side and tapers toward the external edge of the block lock, toward the longitudinal web, whereas the receptacle pockets, the retaining grooves being configured in the flanks of the latter, in the separation plane comprise the narrow side and from said separation plane widen in an outward manner toward the longitudinal web.

The receptacle regions, when viewed in the cross section or the lateral view, respectively, are preferably configured so as to be trapezoid. In the case of a trapezoid, the delimitation edges are configured so as to be straight, this subsequently being more readily machinable and easier in terms of mutually adapting said delimitation edges in comparison to curved shapes which are in principle likewise conceivable. On account of this configuration of the connection regions of the half-elements, an assembly direction which is not exactly perpendicular to the longitudinal axis but is set so as to be oblique t the latter at an angle of approximately 60° to 85° is achieved.

A further particularity lies in that the assembly can take place in either of two ways. The half-elements, while including the end-proximal chain links, can be plug-fitted in the oblique assembly direction mentioned until said half-elements bear on one another, before an axial push in the longitudinal direction finally takes place by way of which the form-fit is established between the half-elements.

According to another variant of assembly using the same half-elements, a plurality of steps are successively performed transversely to the longitudinal axis and along the latter, on account of which a staircase-shaped motion profile results in the lateral view. The second variant of assembly enabled by the block lock according to the invention has the advantage that a provisional form-fit is already achieved in an intermediate position such that the half-elements can no longer fall apart already after the first sequence of in each case one transverse movement and one longitudinal movement.

The staircase-shaped assembly enables the assembly in the lying-down part of the chain, for example, without the chain ends having to be held up. For example, the lower half-element can be placed onto the subsurface for assembly.

The end-proximal chain links of the parts of the chain to be connected to one another are in each case placed into one of the half-elements, wherein it is preferably provided that in each case one inner flank on the half-element is able to taper off in a hook-shaped manner in the direction of the separation plane such that the chain link is held thereon in a form-fitting manner.

When joining the half-elements, the respective longer retaining web first only needs to be pushed into the receptacle pocket so as to be free therein. Thereafter, said respective longer retaining web can be pushed into the short retaining groove by way of a slight advancing movement in the longitudinal direction.

In the further course of the assembly, the half-elements are then once again compressed transversely to the longitudinal direction such that the long retaining web, which lies closer to the separation plane, is moved out of the short retaining groove up to the level of the neighboring long retaining groove.

Finally, another advancing movement in the longitudinal direction takes place, in which advancing movement both retaining webs are then pushed into the retaining grooves that in terms of length are assigned to said to retaining webs, the latter reaching their terminal positions.

The assembly direction is thus not necessarily linear but can also take place in a staircase-shaped manner, wherein the two chain links in the latter variant are already reliably held by way of the intermediate step, and the two half-elements are mutually coupled in a form-fitting manner to the extent that said half-elements can no longer be inadvertently pulled apart.

The strength of the block lock is not compromised despite the facilitated assembly. The central web, which is preferably present despite the short assembly distance, prevents the halves flexing inward under stress, on account of which the toothings are in turn relieved of additional stresses on account of flexing. The central web of the block lock is preferably formed by two individual central webs which from the longitudinal webs of the half-elements extend in each case inward, thus in the direction of the eyes to be configured. The end sides of the central webs lie in front of one another in the separation plane.

The central web can in each case extend up to the central axis of the block lock such that a seamless web is present after joining. The central web can however in each case also be configured so as to be somewhat smaller in height such that the central webs that point toward one another by way of a gap nevertheless ensure that the two chain links are separated. To this end, the gap needs only to be smaller than the diameter of the chain links to be connected.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block lock according to the invention in a perspective view prior to the assembly;

FIG. 2 shows a half-element for a block lock in a perspective view;

FIGS. 3A-3D show the block lock in various assembly steps, in each case in a lateral view; and

FIG. 4 shows the completely assembled block lock in a lateral view.

### DETAILED DESCRIPTION

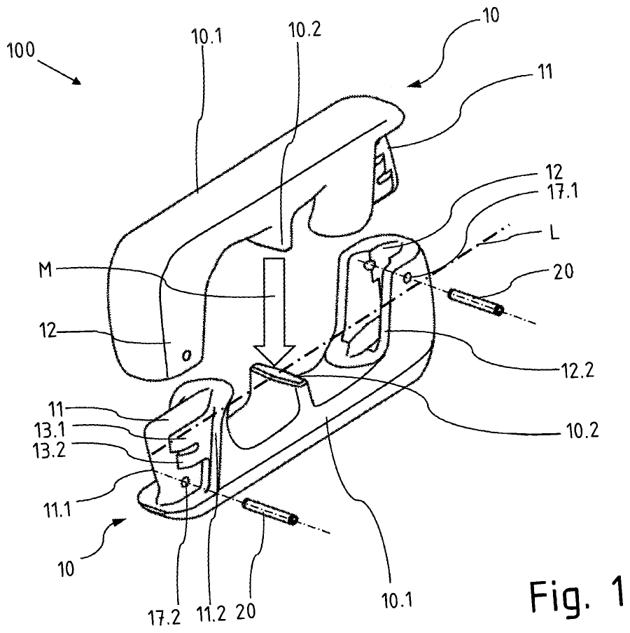

FIG. 1 in a perspective exploded view shows a block lock 100 which is formed from two half-elements 10. The half-elements 10 are preferably of identical configuration. The arrow between the half-elements 10 identifies the assembly direction M in which the upper half-element 10 is placed onto the lower half element 10, and the chain-dotted line identifies the position of a longitudinal axis L.

Each half-element 10 possesses a longitudinal web 10.1, one insertion plug 11 being configured at one end of said longitudinal web 10.1, wherein the width of said insertion plug 11 is significantly reduced in comparison to the other portions. Two retaining webs 13.1, 13.2 of dissimilar lengths are configured on the lateral external flanks of the insertion plug 11. The insertion plug 11 is delimited by a flank 11.2 which extends obliquely upward, specifically so as to be inclined in relation to the center. The end-proximal edge 11.1 of the insertion plug 11 however extends in each case from the external side obliquely outward to a separation plane which runs through the longitudinal axis L, such that a trapezoidal shape of the insertion plug 11 results in the lateral view.

A receptacle pocket 12 which is likewise delimited by an oblique flank 12.2 is configured at the opposite end of the longitudinal web 10.1 of the half-element 10, wherein the inclination of said flank 12.2 corresponds to the inclination of the flank 11.2 on the insertion plug 11. The receptacle pockets 12 and the insertion plugs 11 form mutually complementary receptacle regions, that is to say that recesses and grooves on the one side interact with protrusions and webs on the respective mating piece.

A central web 10.2 which projects transversely from the longitudinal web 10.1 is configured between the insertion plug 11 and the receptacle pocket 12. Moreover provided are bores 17, 18 into which safety pins 20 can be inserted after the half-elements 10 have been joined.

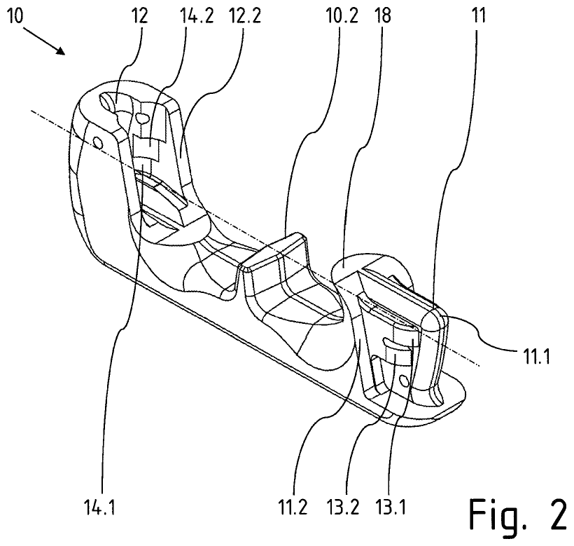

FIG. 2 shows a single half-element 10 in a perspective view so as to highlight in particular the design of the retaining webs 13.1, 13.2 in the insertion plug 11, and the associated retaining grooves 14.1, 14.2 in the receptacle pocket 12. The webs 13.1, 13.2 and the grooves 14.1, 14.2 possess upper and lower edges which are axially parallel and serve for transmitting force and in each case taper off so as to be radiused toward the end sides in order to facilitate the assembly.

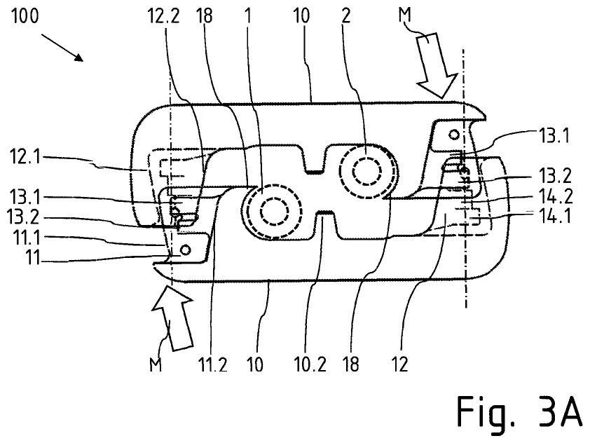

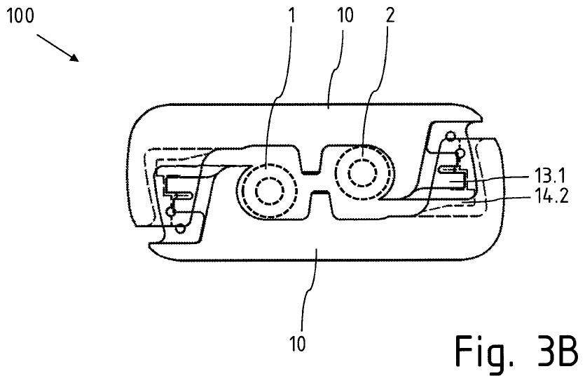

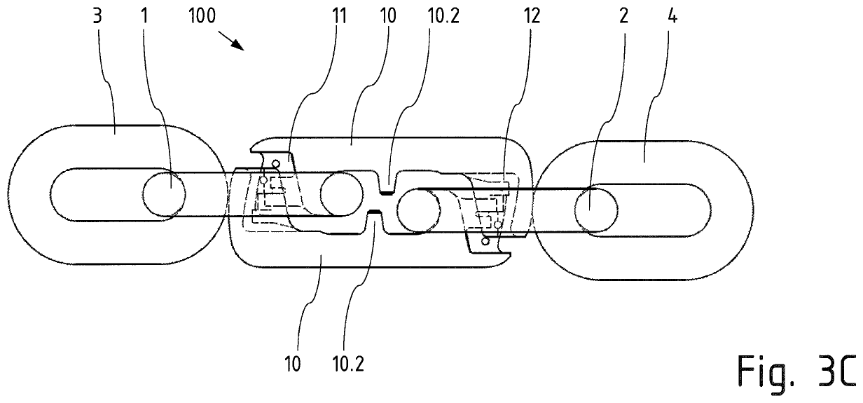

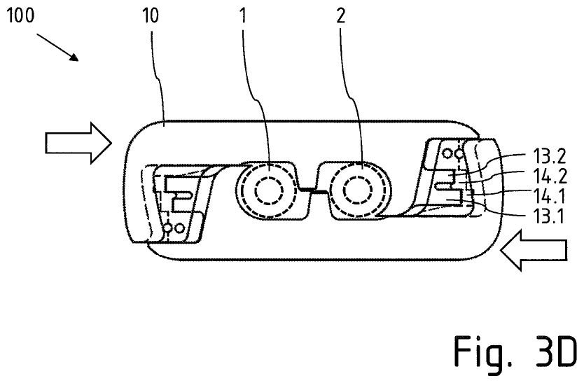

FIG. 3A in a lateral view shows a first assembly step. A chain link 1 which is held in a form-fitting manner on a hook-shaped protrusion 18 is placed into a lower half-element 10 on the left. A further half-element 10 is depicted thereabove. Said further half-element receives a second chain link 2 on the right, the latter by way of a hook-shaped protrusion 18 being likewise already guided and held in an early stage of the assembly. The vertical dashed lines identify the position of that respective edge in the receptacle pocket 12 that first has to be passed by the longer retaining web 13.1 of the insertion plug 11. Since the retaining grooves 14.1, 14.2 as well as the associated retaining webs 13.1, 13.2 are radiused at the end sides, the initial position of the two half-elements 10 illustrated in FIG. 3A is possible only by way of a very minor mutual axial offset. On account thereof, a very short closing distance which can be completely covered within the respective eye of the connected chain links 1, 2 is implemented. Any later pivoting of the block lock 100 into the profile of the chain is thus not required.

The next assembly step in which the retaining elements are mutually converged further such that the respective longer retaining webs 13.1 are positioned so as to be level with the respective shorter retaining grooves 14.2 is shown in FIG. 3B.

FIG. 3C shows this assembly step once again together with the adjacent chain links 1, 2, 3, 4 in order to highlight that the distance available for closing the block lock is limited by virtue of the length and the design of the chain links. In this assembly intermediate step, both half-elements 10 by way of the insertion plugs 11 and receptacle pockets 12 thereof are already positioned completely within the eyes of the adjacent chain links 1, 2, wherein the chain links can remain in the stretched profile of the chain and do not have to be repositioned for assembling the block lock.

Proceeding from the position according to FIGS. 3B and 3C, in order to finally join the half-elements 10, another final staircase-shaped movement is performed in which the half-elements 10 are first pressed against one another along the longitudinal extent of the part of the chain, are pressed apart so as to cancel again the temporary engagement of the long retaining webs 13.1 in the short retaining grooves 13.2, and then pushed transversely such that the position according to FIG. 3D is reached. Proceeding from the latter, the half-elements 10 are moved to the terminal position by a final advancing movement in the longitudinal direction.

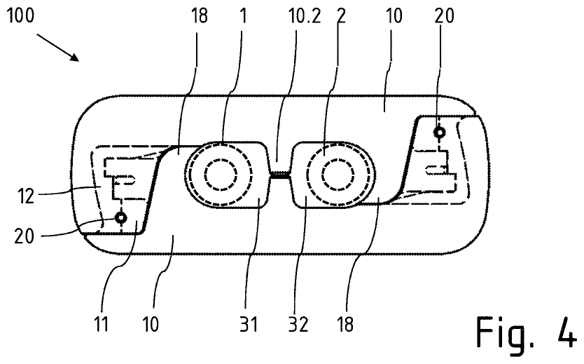

The terminal position is depicted in FIG. 4. The long retaining webs and retaining grooves 14.1, 13.1 mutually engage as do the short retaining webs and retaining grooves 14.2, 13.2. The central webs 10.2 bear on one another such that two mutually separate eyes 31, 32 are configured. The ends of the eyes 31, 32 are in each case formed by the radiused inner flanks 18 in the shape of hooks. The inserted safety pins 20 secure the mutual position of the half-elements 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A block lock for round steel chains, the block comprising:
two half-elements, which for opening and closing the block lock, are displaceable relative to one another and have ends that are connected to one another by way of one longitudinal web, of which ends one end has in each case one insertion plug having a width that is reduced in comparison to the longitudinal web and retaining webs that are integrally molded on both sides, wherein at least two parallel retaining webs are disposed on top of one another on each side, and of which ends the respective other end has a receptacle pocket that serves for receiving the insertion plug;
at least two retaining grooves for configuring a toothing by receiving the retaining webs and being configured on top of one another in each case on the two lateral internal flanks of said receptacle pocket; and
a central web extending inward from at least one longitudinal web toward a longitudinal axis,
wherein, when viewed laterally, the insertion plug widens and the length of the retaining webs increases from the longitudinal web toward the end of the insertion plug; and
wherein, when viewed laterally, the receptacle pocket tapers and the length of the retaining grooves decreases from the longitudinal web toward the end of said receptacle pocket.

2. The block lock as claimed in claim 1, wherein the insertion plug has two retaining webs and the receptacle pocket has two retaining grooves.

3. The block lock as claimed in claim 1, wherein the retaining webs and retaining grooves configured in dissimilar lengths are disposed on the receptacle regions which, when viewed in the cross section, are trapezoid and formed by insertion plugs and receptacle pockets, wherein the insertion plug by way of the outward-projecting retaining webs at a separation plane has the longer side and tapers toward the external edge of the block lock, toward the longitudinal web, and wherein the receptacle pockets, the retaining grooves being configured in the lateral flanks of the latter, in the separation plane comprise in each case the narrow side and from said separation plane widen in an outward manner toward the longitudinal web.

4. The block lock as claimed in claim 1, wherein the insertion plug and the receptacle pocket of the half-elements, when viewed laterally, are delimited by external edges and flanks which are aligned so as to be oblique in relation to the longitudinal axis.

5. The block lock as claimed in claim 4, wherein the insertion plug and the receptacle pocket of the half-elements, when viewed laterally, are delimited by external edges and flanks which are aligned at an angle of 60° to 85° in relation to the longitudinal axis.

6. The block lock as claimed in claim 1, wherein the insertion plug and the receptacle pocket are in each case provided with one transverse bore that serves for receiving a securing element.

7. The block lock as claimed in claim 1, wherein the central web on each half-element extends in each case so far toward the central axis of the block lock that a seamless central web is formed once the half-elements have been joined.

8. The block lock as claimed in claim 1, wherein a central web with a gap is formed once the half-elements have been joined.
